(19) United States
(12) Patent Application Publication
(10) Pub. No.: US 2005/0255917 A1
(43) Pub. Date: Nov. 17, 2005

(54) Direction controller with separating direction control keys

(76) Inventor: Wei Hsu, Taipei Hsien (TW)

Correspondence Address: WEI HSU, 235 Chung-Ho, Box 8-24, Taipei, TW

(21) Appl. No.: 10/846,889

(22) Filed: May 17, 2004

(51) Int. Cl. A63F 13/02

(52) U.S. Cl. 463/37

(57) ABSTRACT

A direction controller with separating direction control keys comprises a control panel; a left handle and a right handle; two trigger keys at a front side of the control panel; a plurality of functions keys; a circuit board installed within the control panel; an electric wire being extended from the control panel; a direction control key set installed on a surface of the left handle including: four sector keys; each of the sector keys having a respective wings extended from a bottom of each sector keys; four long keys; each of the long keys having a respective wings extended from a bottom of each long key; a holed plate having a plurality of sector holes arranged as a flower for receiving the sector keys and a plurality of long holes for receiving the long keys; and each of the long holes being arranged between two adjacent sector holes.

### FIELD OF THE INVENTION

The present invention relates to controllers, and particular to a direction controller with separating direction control keys, wherein the keys for each action are defined and installed clearly so that the user have no incorrect operation. Thereby, the controller can be widely used in the controllers of game machines, TVs, Video players, DVDs, VCDs, CDs, air conditioners, palm type game machines and other remote controllers.

### BACKGROUND OF THE INVENTION

In the prior art controller for TVs, Video players, DVDs, VCDs, CDs, air conditioners, palm type game machines and other remote controller, a disk like controller is attached for controlling the movement of the object in the game. However, it is easy to have incorrect operations in the prior art disk like controller due to other non-related key is pressed as the operations must be performed rapidly. If it is desire to make correct operations, the operations must be performed slowly, but this is often impossible, since the game must be played with a quick speed.

### SUMMARY OF THE INVENTION

Accordingly, the primary object of the present invention is to provide a direction controller with separating direction control keys, wherein the keys for each action are defined and installed clearly so that the user have no incorrect operation. Thereby, the controller can be widely used in the controllers of TVs, Video players, DVDs, VCDs, CDs, air conditioners, palm type game machines and other remote controller.

To achieve above object, the present invention provides a direction controller with separating direction control keys which comprises a control panel; a left handle and a right handle installed at two lateral sides of the control panel; two trigger keys at ends of a front side of the control panel; a plurality of functions keys installed on a surface of the right handle; a circuit board installed within the control panel; an electric wire being extended from the control panel; a direction control key set installed on a surface of the left handle including: four sector keys; each of the sector keys having a respective wings extended from a bottom of each sector keys; four long keys; each of the long keys having a respective wings extended from a bottom of each long keys; a holed plate having a plurality of sector holes arranged as a flower for receiving the plurality of sector keys and a plurality of long holes for receiving the plurality of long keys; each of the long holes being arranged between two adjacent sector holes.

The various objects and advantages of the present invention will be more readily understood from the following detailed description when read in conjunction with the appended drawing.

### BRIEF DESCRIPTION OF THE DRAWINGS

FIG. 1 shows the appearance of the preferred embodiment of the present invention.

FIG. 2 shows the structure of another preferred embodiment of the present invention.

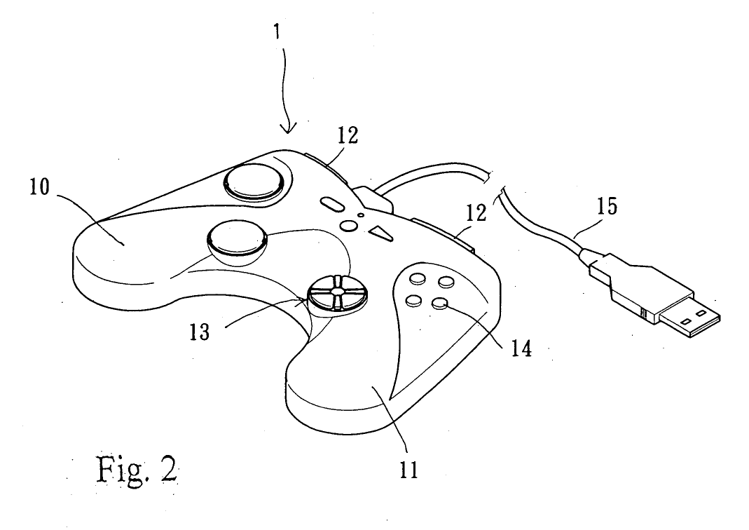

FIG. 3 is the structure of a further preferred embodiment of the present invention.

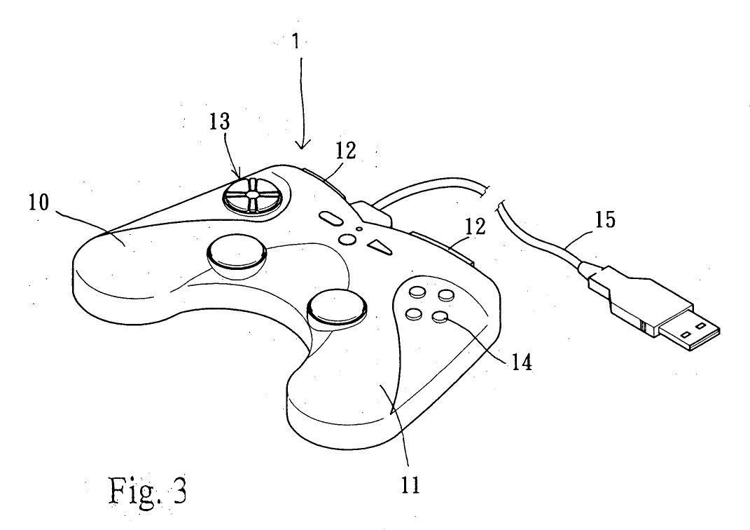

FIG. 4 is an exploded view of the direction control key set of the present invention.

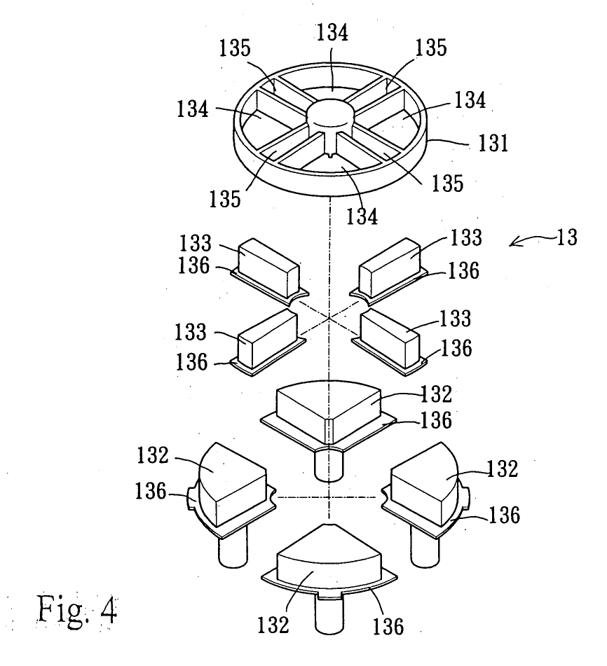

FIG. 5 shows the assembly of the direction control key set of the present invention.

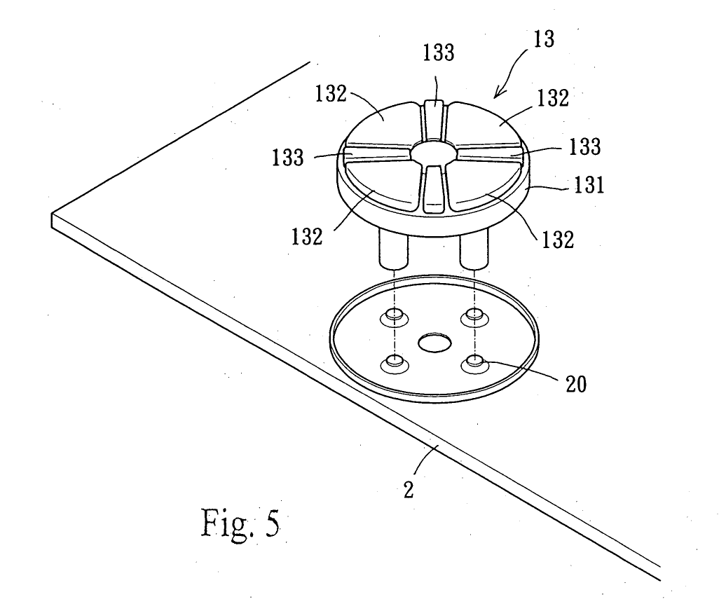

FIG. 6 shows the front view and back side view of the direction control key set of the present invention.

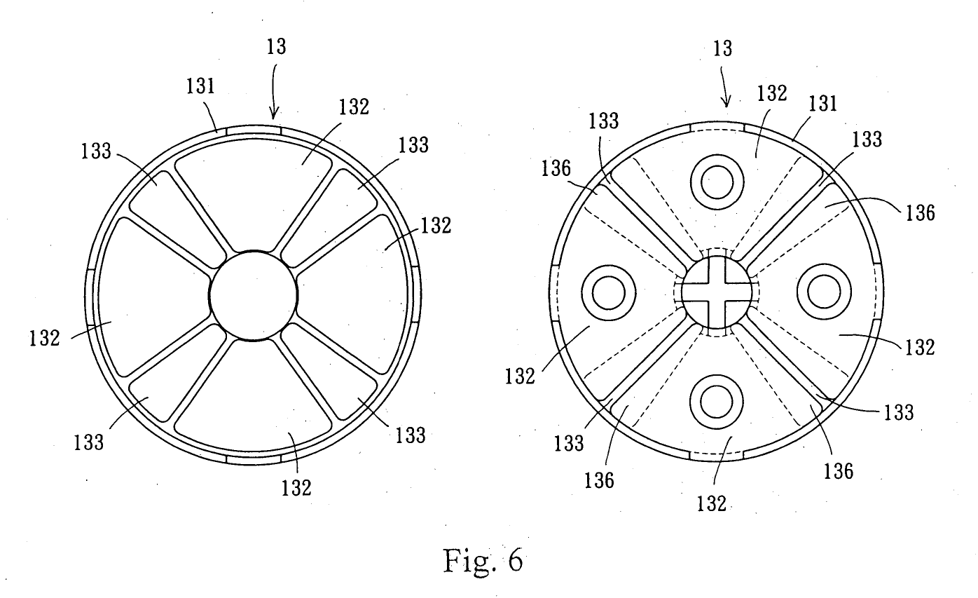

FIG. 7 is a schematic view showing the action of the direction control key set according to the present invention.

FIG. 8 is a schematic view showing the operation of the direction control key set according to the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

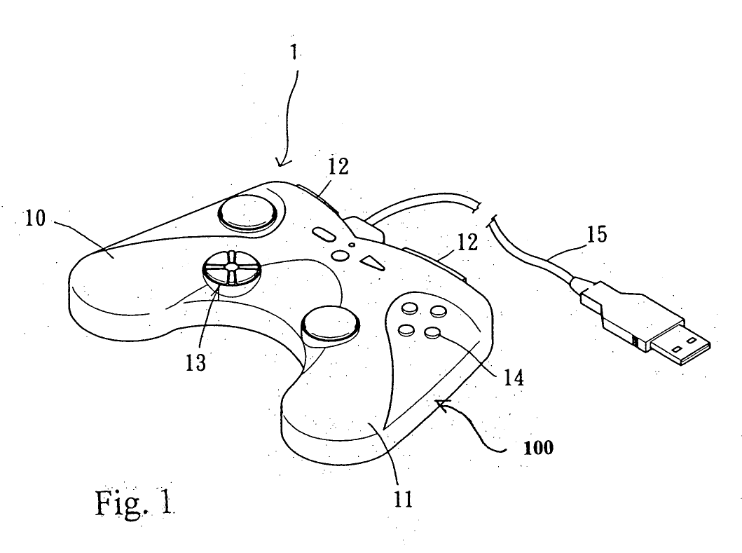

With reference to appended drawings, the separated direction controller 1 of the present invention, as shown in FIG. 1 the following elements.

A control panel 100 serves for installing other elements of the controller.

A left handle 10 and a right handle 11 are installed at two lateral sides of the control panel 100 for being held by operators

Two trigger keys 12 are at ends of the front side of the control panel 100. As the operator holds the left handle 10 and right handle 11, the use can touch the trigger keys 12 easily and conveniently.

A direction control key set 13 is installed in a hole in a surface of the left handle 10. A bottom of the direction control key set 13 is in contact with an upper side of a conductive glue layer on a circuit board 2. The direction control key set 13 includes the following elements.

A plurality of sector keys 132, for example, four sector keys 132, represents the operation of upward, downward, rightward and leftward movements. Each of the sector keys 132 has a respective wing 136 extended from a bottom of each sector key 132.

A plurality of long keys 133, for example, four long keys 133, represent upper left, upright, lower left and lower right movements; and each of the long keys 133 has a respective wing 136 extended from a bottom of each long key 133.

A holed plate 131 has a plurality of sector holes 134 arranged as a flower for receiving the plurality of sector keys 132 and a plurality of long holes 135 for receiving the plurality of long keys 133. Each of the long holes 135 is arranged between two adjacent sector holes 134.

A plurality of functions keys 14 are installed on a surface of the right handle 11.

However, the installation of the direction control key 13 and the function keys 14 are not confined to be on the left handle 10 or right handle 11. These keys can be installed at other place as desired by the designer. All these are within the scope and spirit of the present invention.

A circuit board 14 is installed within the control panel 100. An electric wire 15 is extended from the control panel 100.

In operation of the present invention, the two hands of the user hold the left handle 10 and right handle 11. The left thumb places on the direction control key set 13 and the right thumb places upon the function keys 135. The user presses the keys as desired in the playing process. For example, if the right sector key 132 is pressed, it represents to move forwards. If the lower sector key 132 is pressed, it represents to move backwards. If the upper sector key 132 is pressed, it represents to jump. If the lower sector key 132 is pressed, it represents to squat. If the lower right long key 133 is pressed, it represents to move forwards and jump. If the upper left key 133 is pressed, it represents to move backwards and jump. If the lower right long key 133 is pressed, it represents to move forwards and squat. If the lower left long key 133 is pressed, it represents to move backwards and squat. If one key, 132, 133 is pressed continuously, the actions will be performed continuously.

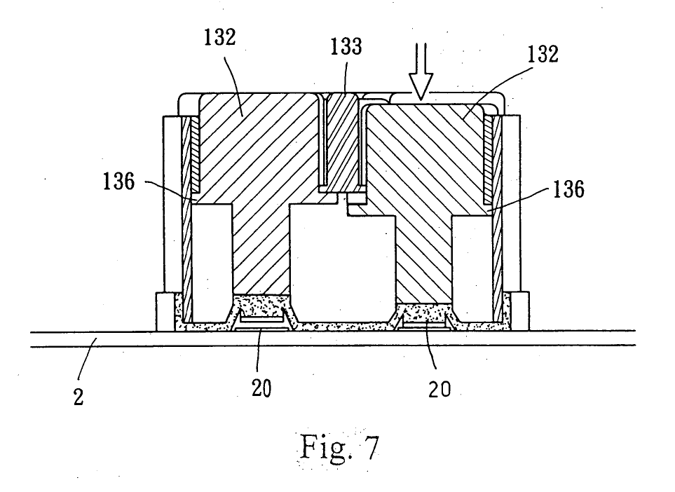

Referring to FIG. 7, since each above mentioned keys 132, 133 performs an action independently. Thereby, in playing, it is difficult to make a mistake. Namely, the user has correct action. Thus, the game can be played successfully. Moreover, in the arrangement of the circuit, each sector key 132 has a respective conductive glue layer 20 therebelow so that the signal transfer will not interfere to one another.

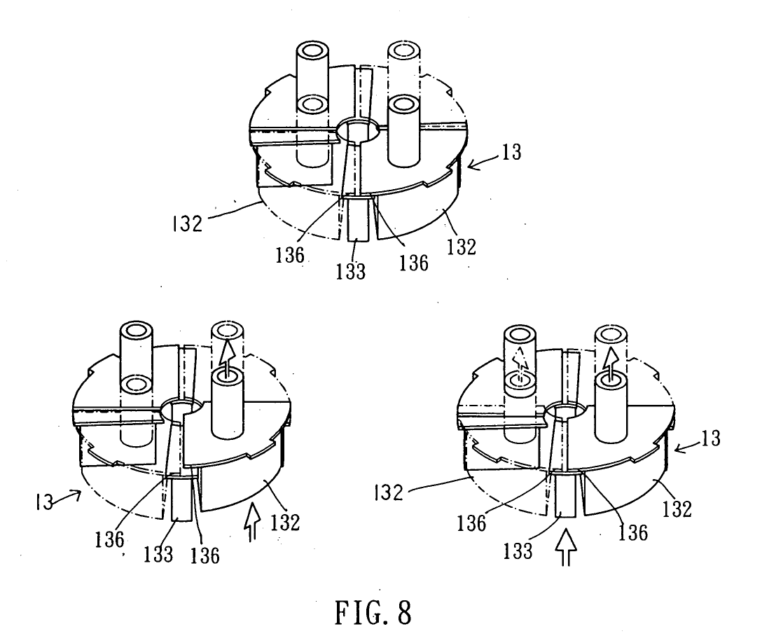

Referring to FIG. 8, in this arrangement, when each long key 133 is pressed, a respective sector key 132 with respect to the lone key 133 will be driven to move downwards so that two actions are acted at the same time, or a default action set for the long key 133 and sector key 132 is performed.

Moreover, from above description, it is appreciated by the special designed separated direction control key set 13 on the controller 1, in the process of playing a game, the object can move rapidly and correctly without any mistake. Thereby, the intention of a player can be correctly performed so that the thought and operation of the user are consistent. Moreover, in the present invention, the appearance of the present invention is beautiful and vivid so as to match the requirement of young people.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A direction controller with separating direction control keys comprising:
a control panel;
a left handle and a right handle installed at two lateral sides of the control panel;
two trigger keys installed at front side of the control panel;
a plurality of functions keys installed on a surface of the right handle;
a circuit board installed within the control panel; an electric wire being extended from the control panel; and
a direction control key set installed on a surface of the left handle including:
four sector keys; each of the sector keys having a respective wing extended from a bottom of each sector key;
four long keys; each of the long keys having a respective wing extended from a bottom of each long key;
a holed plate having a plurality of sector holes arranged as a flower for receiving the plurality of sector keys and a plurality of long holes for receiving the plurality of long keys; each of the long holes being arranged between two adjacent sector holes.

2. The direction controller with separating direction control keys as claimed in claim 1, wherein each of the sector keys and long keys is used as a direction control key.

3. The direction controller with separating direction control keys as claimed in claim 1, wherein at least one of the sector keys and long keys is used as a direction control key.

4. The direction controller with separating direction control keys as claimed in claim 1, wherein each of the sector keys and long keys is in contact with a respect conductive glue layer on the circuit board for transferring a signal from the respective key.

5. The direction controller with separating direction control keys as claimed in claim 1, wherein the direction control key set is installed on one of the left handle and right handle so as to match the operation requirement of users.
